(19) United States
(12) Patent Application Publication
(10) Pub. No.: US 2026/0101209 A1
(43) Pub. Date: Apr. 9, 2026

(54) TWO-STAGE SPATIAL DOMAIN BASIS SELECTION FOR COHERENT JOINT TRANSMISSION

(71) Applicant: QUALCOMM Incorporated, San Diego, CA (US)

(72) Inventors: Chao WEI, Beijing (CN); Jing DAI, Beijing (CN); Hao XU, Beijing (CN)

(21) Appl. No.: 19/114,751

(22) PCT Filed: Nov. 11, 2022
(86) PCT No.: PCT/CN2022/131318

§ 371 Date: Mar. 24, 2025

(51) Int. Cl. H04W 24/08

(52) U.S. Cl. CPC H04W 24/08

(57) ABSTRACT

Certain aspects of the present disclosure provide techniques for two-stage spatial domain (SD) basis selection for coherent joint transmission (CJT). An example method, performed by a UE, includes receiving configuration information indicating resources associated with multiple transmission reception points (TRPs) with which the UE is configured to communicate using a codebook structure based on a matrix of spatial domain (SD) bases, a matrix of coefficients, and a matrix of frequency domain (FD) bases, measuring channel state information (CSI) reference signals (CSI-RSs) from the multiple TRPs according to the configuration information, and transmitting at least two stages of information regarding selection of the SD bases.

### BACKGROUND

### Field of the Disclosure

Aspects of the present disclosure relate to wireless communications, and more particularly, to techniques for two-stage spatial domain (SD) basis selection for coherent joint transmission (CJT).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving configuration information indicating resources associated with multiple transmission reception points (TRPs) with which the UE is configured to communicate using a codebook structure based on a matrix of spatial domain (SD) bases, a matrix of coefficients, and a matrix of frequency domain (FD) bases; measuring channel state information (CSI) reference signals (CSI-RSs) from the multiple TRPs according to the configuration information; and transmitting at least two stages of information regarding selection of the SD bases.

Another aspect provides a method for wireless communications by a network entity. The method includes transmitting configuration information indicating resources associated with multiple TRPs with which a UE is configured to communicate using a codebook structure based on a matrix of SD bases, a matrix of coefficients, and a matrix of FD bases; and receiving at least two stages of information regarding selection, by the UE, of the SD bases.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a conceptual example of precoder matrices.

FIG. 6 is a block diagram illustrating an example of codebook based CSF.

FIG. 7 illustrates example transmitter receiver point (TRP) scenarios.

FIG. 8 illustrates a conceptual example of precoder matrices.

FIG. 9 illustrates a conceptual example of coherent joint transmission (CJT) across multiple TRPs.

FIG. 10 depicts an example of channel state information (CSI) parts.

FIG. 11 depicts an example algorithm for decoding a spatial domain (SD) basis selection indicator.

FIG. 12 depicts an example combination coefficients table.

FIG. 13 depicts example values of spatial domain basis selection indicators.

FIG. 14 depicts a call flow diagram for multi-stage SD basis selection information reporting.

FIG. 15 depicts an example of 2-stage SD basis selection information generation.

FIGS. 16 and 17 depict example overhead comparisons of SD basis selection reporting techniques.

FIG. 18 depicts a method for wireless communications.

FIG. 19 depicts a method for wireless communications.

FIG. 20 depicts aspects of an example communications device.

### DETAILED DESCRIPTION

Aspects of the present disclosure provide apparatuses, methods, processing systems, and computer-readable mediums for two-stage spatial domain (SD) basis selection for coherent joint transmission (CJT).

Various enhancements of channel state information (CSI) acquisition in certain scenarios are being considered, such as coherent joint transmission (CJT) targeting certain frequency ranges (e.g., FR1) and multiple transmitter receiver points (e.g., up to 4 TRPs). Certain assumptions may be made in such cases, such as an ideal backhaul and synchronization as well as the same number of antenna ports across TRPs.

The motivation for enhanced CSI for CJT scenarios, may be to enable larger number of ports for low-frequency bands, with distributed TRPs/panels. For a single-TRP or panel (TRP/panel) with, for example, 32 ports, the antenna array size would be too large for practical deployment. With the introduction of CJT mTRP, and with TRP number increased from 2 to 4, there may be a need to define CSI report with more possible measurement hypotheses. An increased number and combination of hypotheses increases ULE CSI processing overhead.

For CJT, per-TRP SD basis selection is reported by the UE. A value of the number of SD basis selection for TRP n, Lₙ may also be reported by the UE or configured by the network (e.g., by a gNB). A typical scheme for reporting the per-TRP SD basis selection is relatively computationally complex, using a first number of bits to indicate a selection of Lₙ SD bases out of N₁N₂ bases for TRP n and a total number of bits, that is a sum of the number of bits for N TRPs with

$${L}_{tot} = {\sum }_{n = 1}^{N} {L}_{n}$$

where Lₜₒₜ is a network-configured value.

The baseline scheme may have potential issues. One potential issue is a relatively large overhead when the value of Lₜₒₜ is large. For example, in a worst case scenario (N=4, N₁N₂=16), a total 28 and 40 bits are required for Lₜₒₜ=8 and 12, respectively, assuming Lₙ=Lₜₒₜ/N. The baseline scheme is also relatively complex, since the SD basis selection is separately encoded or decoded for each TRP (e.g., N times complexity increase for encoding/decoding compared to the single TRP (sTRP) scenario).

Aspects of the present disclosure provide a mechanism for reporting per-TRP SD basis selection in multiple stages. For example, rather than report a single encoded combination value for each TRP, multiple indicators may be reported, resulting in reduced complexity and, in some cases, reduced overhead.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

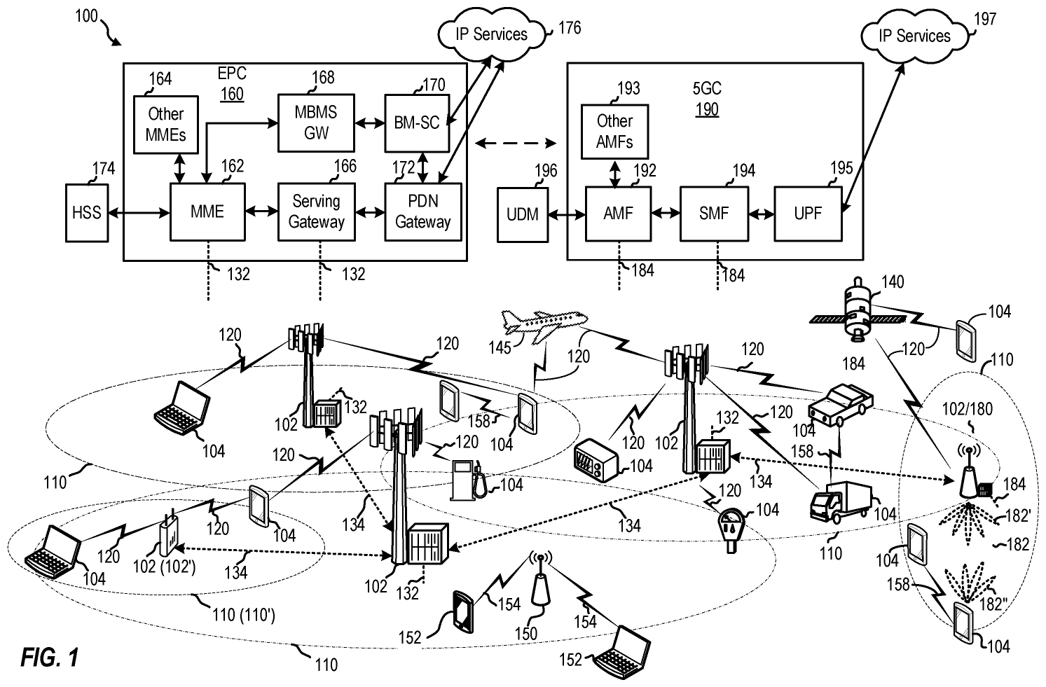

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), abase station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

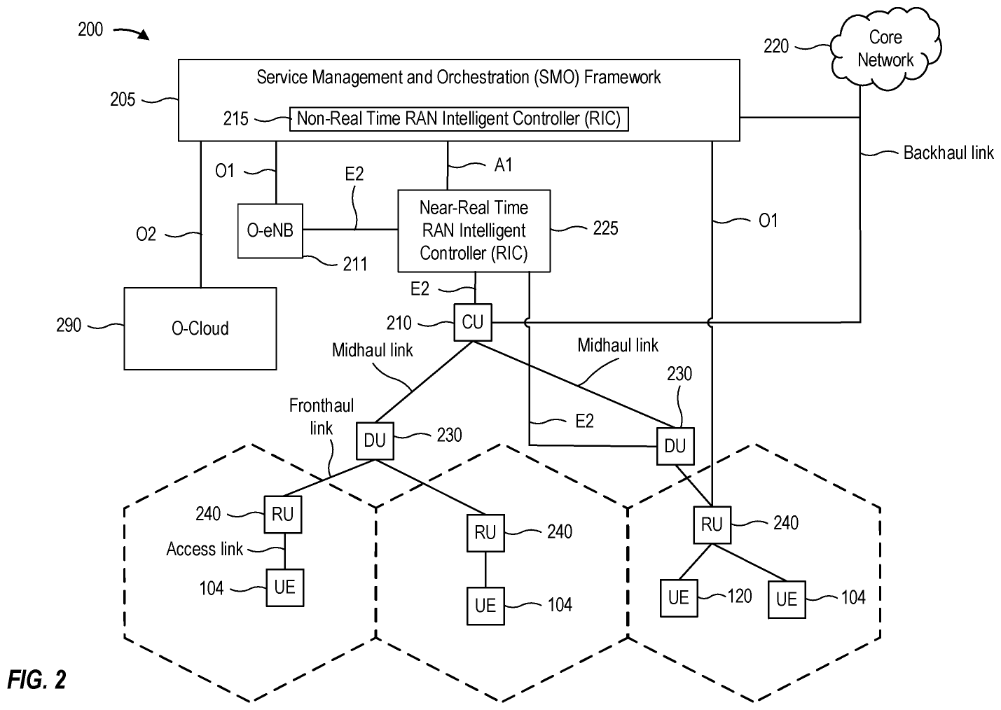

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and ULE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

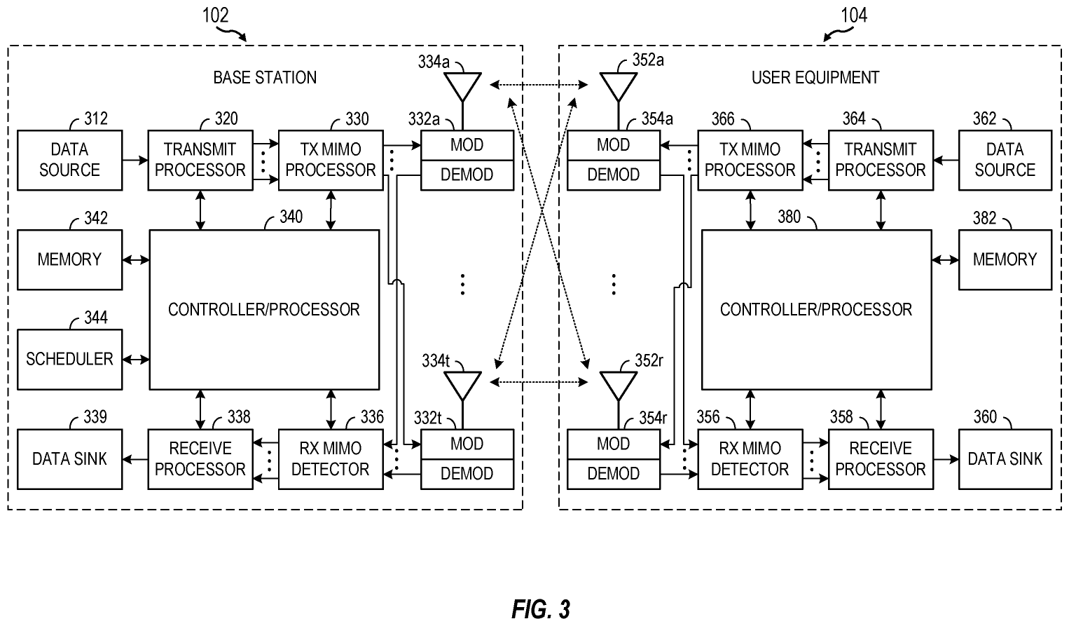

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, ULE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

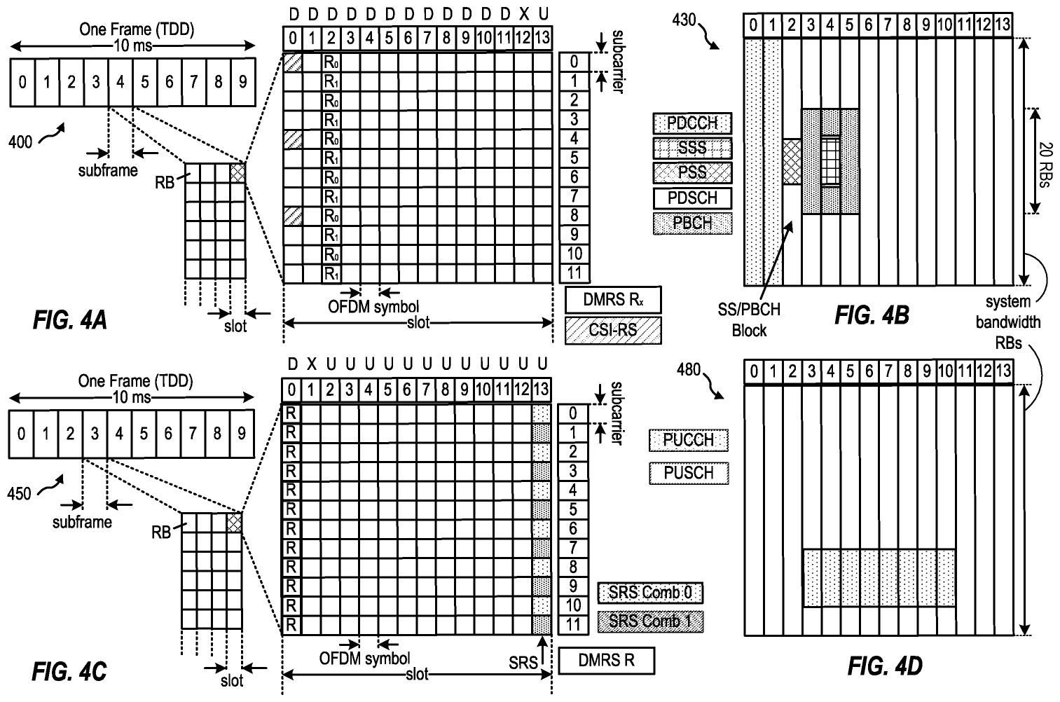

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 21×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example CSI Report Configuration

Channel state information (CSI) may refer to channel properties of a communication link. The CSI may represent the combined effects of, for example, scattering, fading, and power decay with distance between a transmitter and a receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically measured at the receiver, quantized, and fed back to the transmitter.

The time and frequency resources that can be used by a user equipment (UE) to report CSI are controlled by a base station (BS) (e.g., gNB). CSI may include channel quality indicator (CQI), precoding matrix indicator (PMI), CSI-RS resource indicator (CRI), SS/PBCH Block Resource indicator (SSBRI), layer indicator (LI), rank indicator (RI) and/or L1-RSRP. However, as described below, additional or other information may be included in the report.

A UE may be configured by a BS for CSI reporting. The BS may configure UEs for the CSI reporting. For example, the BS configures the UE with a CSI report configuration or with multiple CSI report configurations. The CSI report configuration may be provided to the UE via higher layer signaling, such as radio resource control (RRC) signaling (e.g., CSI-ReportConfig). The CSI report configuration may be associated with CSI-RS resources for channel measurement (CM), interference measurement (IM), or both. The CSI report configuration configures CSI-RS resources for measurement (e.g., CSI-ResourceConfig). The CSI-RS resources provide the UE with the configuration of CSI-RS ports, or CSI-RS port groups, mapped to time and frequency resources (e.g., resource elements (REs)). CSI-RS resources can be zero power (ZP) or non-zero power (NZP) resources. At least one NZP CSI-RS resource may be configured for CM.

For the Type II codebook, the PMI is a linear combination of beams; it has a subset of orthogonal beams to be used for linear combination and has per layer, per polarization, amplitude and phase for each beam. For the PMI of any type, there can be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI on physical uplink control channel (PUCCH) may be triggered via RRC. Semi-persistent CSI reporting on physical uplink control channel (PUCCH) may be activated via a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger state (e.g., CSI-AperiodicTriggerStateList and CSI-SemiPersistentOnPUSCH-TriggerStateList). The CSI report trigger for aperiodic CSI and semi-persistent CSI on PUSCH may be provided via downlink control information (DCI).

The UE may report the CSI feedback (CSF) based on the CSI report configuration and the CSI report trigger. For example, the UE may measure the channel on which the triggered CSI-RS resources (associated with the CSI report configuration) is conveyed. Based on the measurements, the ULE may select a preferred CSI-RS resource. The ULE reports the CSF for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

Each CSI report configuration may be associated with a single downlink (DL) bandwidth part (BWP). The CSI report setting configuration may define a CSI reporting band as a subset of subbands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

In certain systems, the UE can be configured via higher layer signaling (e.g., in the CSI report configuration) with one out of two possible subband sizes (e.g., reportFreqConfiguration contained in a CSI-ReportConfig) which indicates a frequency granularity of the CSI report, where a subband may be defined as NP

$${N}_{PRB}^{SB}$$

contiguous physical resource blocks (PRBs) and depends on the total number of PRBs in the bandwidth part. The UE may further receive an indication of the subbands for which the CSI feedback is requested. In some examples, a subband mask is configured for the requested subbands for CSI reporting. The UE computes precoders for each requested subband and finds the PMI that matches the computed precoder on each of the subbands.

### Compressed CSI Feedback Coefficient Reporting

As discussed above, a user equipment (UE) may be configured for channel state information (CSI) reporting, for example, by receiving a CSI configuration message from the base station. In certain systems (e.g., 3GPP Release 15 5G NR), the UE may be configured to report at least a Type II precoder across configured frequency domain (FD) units. For example, the precoder matrix W for layer r includes the W₁ matrix, reporting a subest of selected beams using spatial compression and the W_{2,r} matrix, reporting (for cross-polarization) the linear combination coefficients for the selected beams (2L) across the configured FD units:

$${W}_{r} = {\sum }_{i = 0}^{2 L - 1} {b}_{i} \cdot {c}_{i} , where {c}_{i} = [ {\underbrace{{c}_{i , 0} … {c}_{i , {N}_{3} - 1}}}_{{N}_{3}} ] ,$$

where bᵢ is the selected beam, cᵢ is the set of linear combination coefficients (i.e., entries of W_{2,r} matrix), L is the number of selected spatial beams, and N₃ corresponds to the number of frequency units (e.g., subbands, resource blocks (RBs), etc.). In certain configurations, L is RRC configured. The precoder is based on a linear combination of digital Fourier transform (DFT) beams. The Type II codebook may improve MU-MIMO performance. In some configurations considering there are two polarizations, the W_{2,r} matrix has size 2L×N₃.

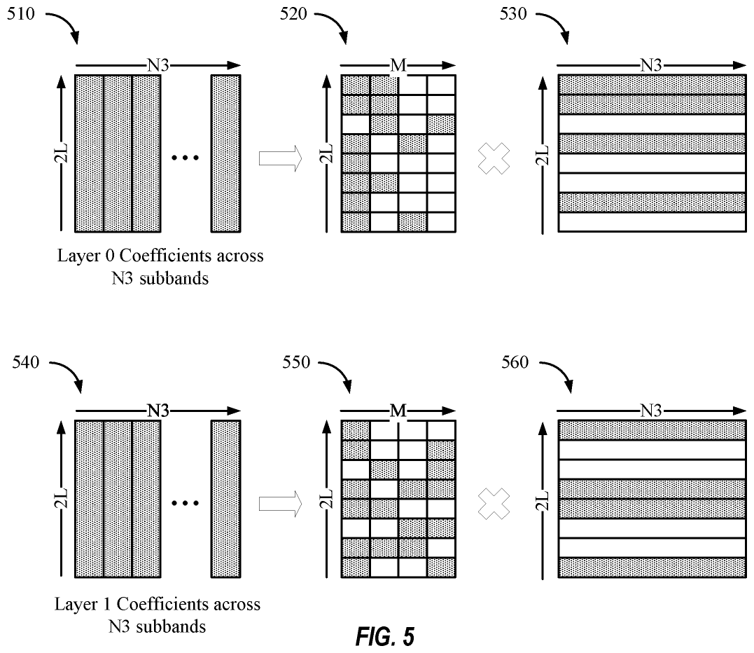

In certain systems (e.g., Rel-16 5G NR), the UE may be configured to report FD compressed precoder feedback to reduce overhead of the CSI report. As shown in FIG. 5, the precoder matrix (W_{2,i}) for layer i with i=0.1 may use an FD compression

$${W}_{f , i}^{H}$$

matrix to compress the precoder matrix into \tilde{W}_{2,i} matrix size to 2L×M (where M is network configured and communicated in the CSI configuration message via RRC or DCI, and M<N₃) given as:

$${W}_{i} = {W}_{1} {\tilde{W}}_{2 , i} {W}_{f , i}^{H}$$

Where the precoder matrix Wᵢ (not shown) has P=2N₁N₂ rows (spatial domain, number of ports) and N₃ columns (frequency-domain compression unit containing RBs or reporting sub-bands), and where M bases are selected for each of layer 0 and layer 1 independently. The \tilde{W}_{2,0} matrix 520 consists of the linear combination coefficients (amplitude and co-phasing), where each element represents the coefficient of a tap for a beam. The \tilde{W}_{2,0} matrix 520 as shown is defined by size 2L×M, where one row corresponds to one spatial beam in W₁ (not shown) of size P×2L (where L is network configured via RRC), and one entry therein represents the coefficient of one tap for this spatial beam. The UE may be configured to report (e.g., CSI report) a subset K₀<2LM of the linear combination coefficients of the \tilde{W}_{2,0} matrix 520. For example, the UE may report K_{NZ,i}<K₀ coefficients (where K_{NZ,i} corresponds to a maximum number of non-zero coefficients for layer-i with i=0 or 1, and K₀ is network configured via RRC) illustrated as shaded squares (unreported coefficients are set to zero). In some configurations, an entry in the \tilde{W}_{2,0} matrix 520 corresponds to a row of

$${W}_{f , 0}^{H}$$

matrix 530. In the example shown, both the \tilde{W}_{2,0} matrix 520 at layer 0 and the \tilde{W}_{2,0} matrix 450 at layer 1 are 2L×M.

The

$${W}_{f , 0}^{H}$$

matrix 530 is composed of the basis vectors (each row is a basis vector) used to perform compression in frequency domain. In the example shown, both the

$${W}_{f , 0}^{H}$$

matrix 530 at layer 0 and the

$${W}_{f , 1}^{H}$$

matrix 560 at layer 1 include M=4 FD basis (illustrated as shaded rows) from N₃ candidate DFT basis. In some configurations, the UE may report a subset of selected basis of the

$${W}_{f , i}^{H}$$

matrix via CSI report. The M bases specifically selected at layer 0 and layer 1. That is, the M bases selected at layer 0 can be same/partially-overlapped/non-overlapped with the M bases selected at layer 1.

### Overview of UE PMI Codebook-Based CSF

A PMI codebook generally refers to a dictionary of PMI entries. In this way, using a PMI codebook, each PMI component from a pre-defined set can be mapped to bit-sequences reported by a UE. A based station receiving the bit-sequence (as CSF) can then obtain the corresponding PMI from the reported bit-sequence.

How the UE calculates PMI may be left to UE implementation. However, how the UE reports the PMI should follow a format defined in the codebook, so the UE and base station each know how to map PMI components to reported bit-sequences.

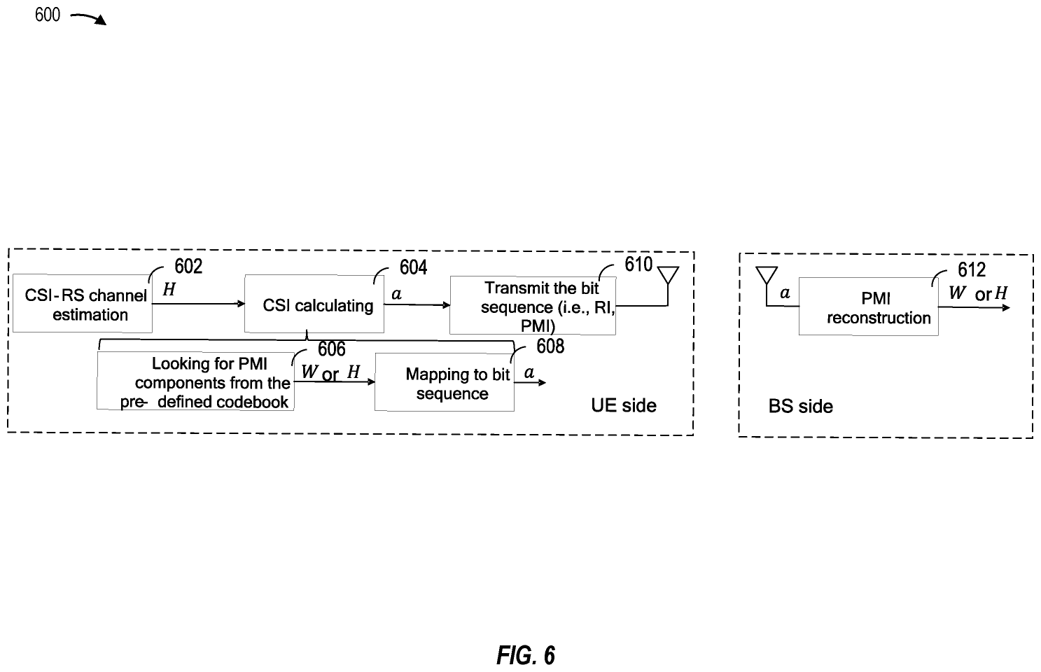

FIG. 6 is a block diagram illustrating an example of codebook based CSF. As illustrated, the UE may first perform channel estimation (at 602) based on CSI-RS to estimate channel H. A CSI calculating block 604 may generate a bit sequence a. As illustrated, bit sequence a may be generated looking for PMI components from the pre-defined PMI codebook for radio channel H or precoder W (at block 606) and mapping the PMI components to the bit sequence a, via block 608. This mapping, from a set of predefined PMI components essentially acts as a form of quantization. The UE transmits the bit sequence a to the BS (e.g., in a CSI report), via block 610.

As illustrated in FIG. 6, at the BS side, the BS receives the bit sequence a reported by the UE. The BS then follows the codebook to obtain each PMI component using the reported bit-sequence a and reconstructs the actual PMI, at block 612, using each PMI component (obtained from the codebook), to recover the radio channel H or precoder W.

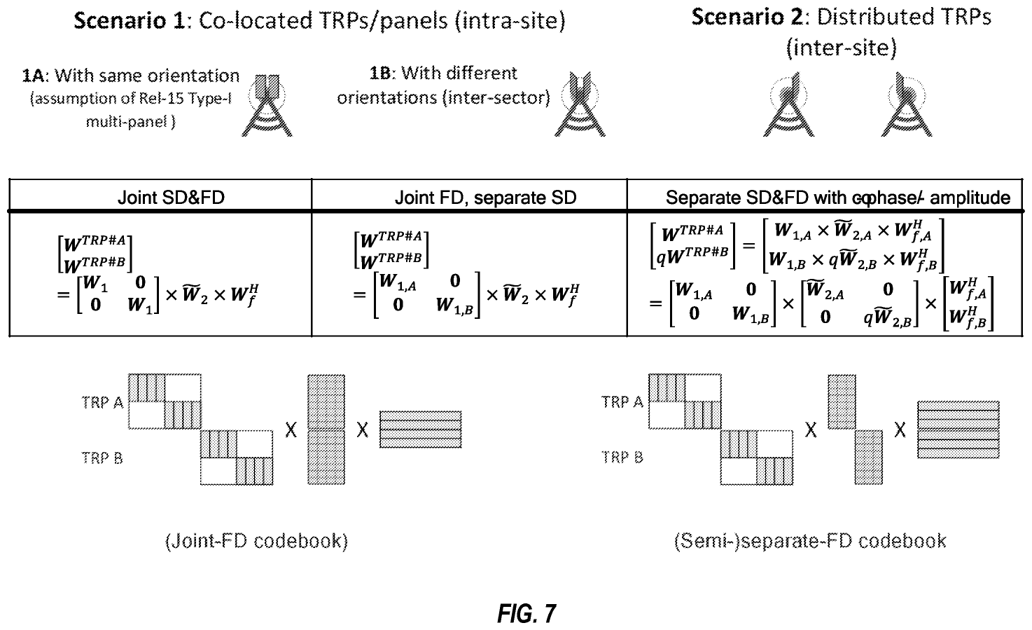

FIG. 7 shows various scenarios for CJT. The scenarios are referred to as Scenario 1A, where co-located TRPs/panes (intra-site) have the same orientation and Scenario 1B, where the panels have different orientations (inter-sector). Another scenario, Scenario 2, may involve Distributed TRPs (inter-site).

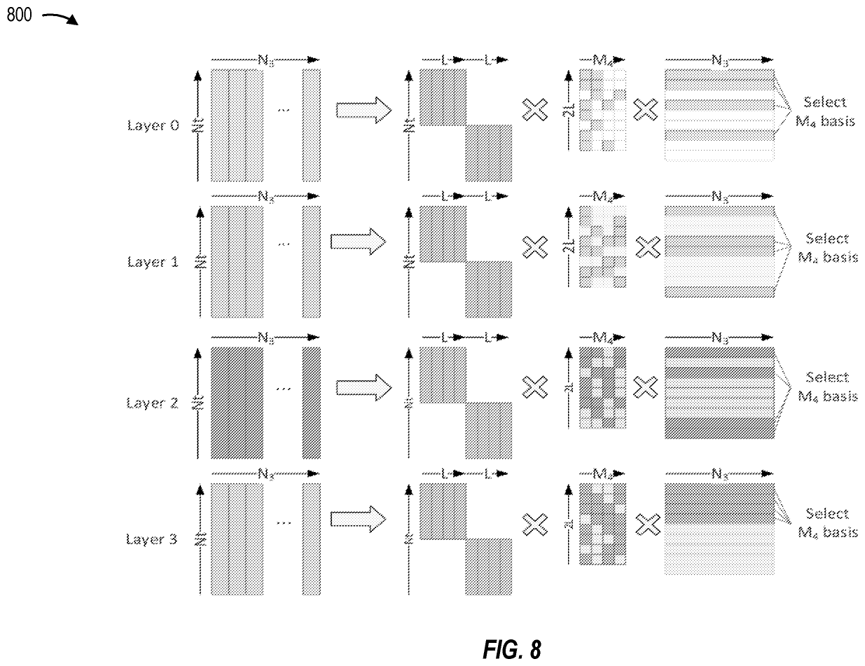

FIG. 8 shows an example for enhanced Type-II (eType-II) CSI where, for each layer, the precoder across a number of N₃ (PMI-)subbands is a Nₜ×N₃ matrix:

$$W : W = {W}_{1} \times {\tilde{W}}_{2} \times {W}_{f}^{H} .$$

where SD bases W₁ (DFT bases) is a Nₜ×2L matrix, W₁ is layer-common, Nₜ=2N₁O₁N₂O₂ (number of Tx antennas—with O₁ and O₂ oversampling) is RRC-configured, L={2,4,6}(number of beams) is RRC-configured FD bases W_{f} (DFT bases) is a M×N₃ matrix, W_{f} is layer-specific, M (number of FD bases) is rank-pair specific, i.e. M₁=M₂ for rank={1,2}, and M₃=M₄ for rank={3,4}, M₁ or M₃ is RRC-configured. Coefficients matrix W₂ is a 2L×M matrix and is layer-specific. For each layer, a UE may report up to K₀ non-zero coefficients, where K₀ is RRC-configured. Across all layers, the UE may report up to 2K₀ non-zero coefficients, where unreported coefficients may be set to zeros.

### Coherent Joint Transmission (CJT) Across Multiple TRPs (mTRPs)

Coherent joint transmission (CJT) across multiple transmission reception points (mTRP) improves coverage and average throughput with high performance backhaul and synchronization. In a first mode (Mode 1) of Type-II codebook for CJT mTRP, per-TRP/TRP-group SD/FD basis selection allows independent FD basis selection across N TRPs/TRP groups. One example formulation (where N=number of TRPs or TRP groups) is:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] where {W}_{f}^{H}$$

varies across N TRPs (as indicated by the subscript 1 . . . N).

A second mode (Mode 2) of Type-II codebook for CJT mTRP, involves per-TRP/TRP group (port-group or resource) SD basis selection and common/joint (across N TRPs) FD basis selection. Example formulation (N=number of TRPs or TRP groups):

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] where {W}_{f}^{H}$$

is common across N TRPs.

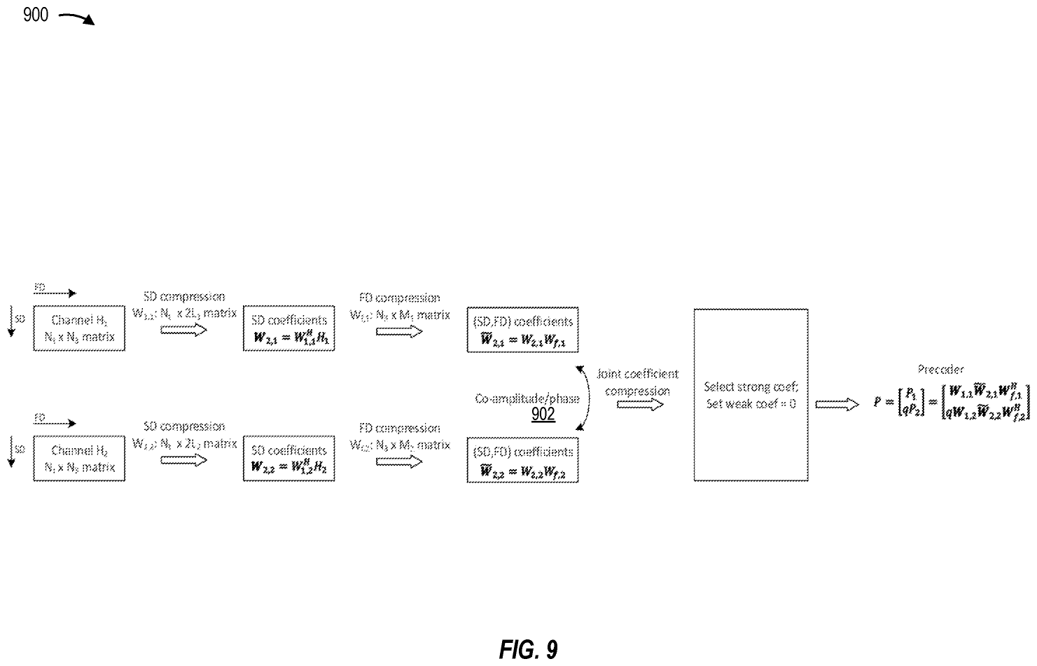

FIG. 9 illustrates one example diagram 900 of CJT across mTRPs. In this example of per-TRP SD/FD basis selection, the number of SD bases can be same or different for each TRP but with a fixed sum. In the illustrated example, for a 2 TRP case, L₁ #L₂ and L₁+L₂=Lₜₒₜₐₗ where Lₜₒₜₐₗ is radio resource control (RRC) configured total # of SD bases. The number of FD basis M_{υ} can also be same or different for each TRP depending on mode 1 or 2. As illustrated, at 902, in FIG. 9, additional per-TRP/polarization amplitude scaling and/or inter-TRP co-phase q may be needed and reported as part of W2

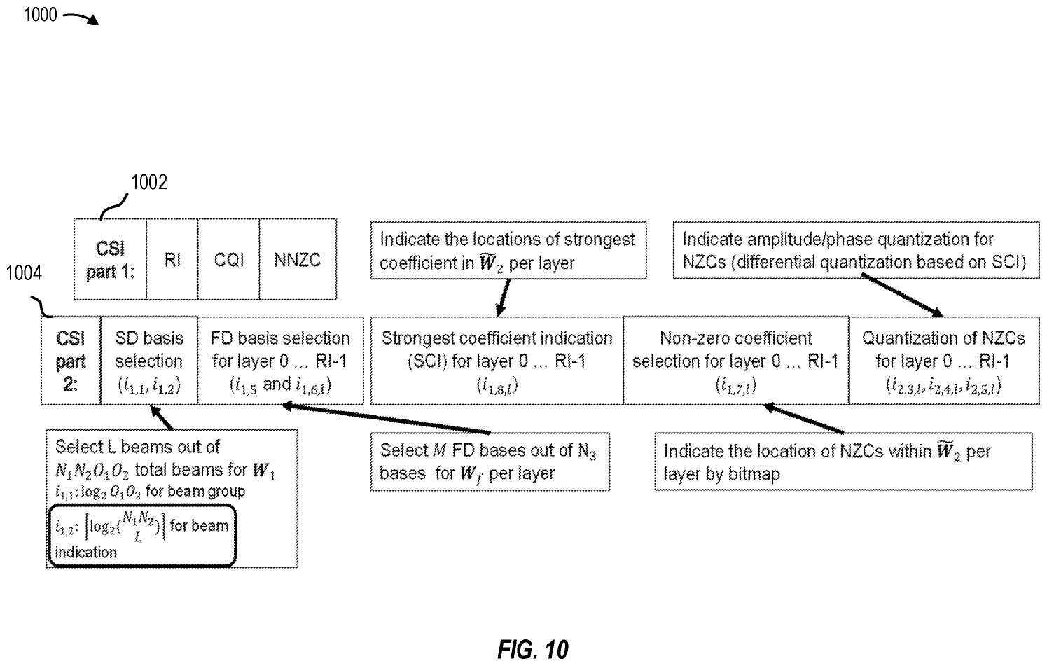

As illustrated in the example diagram 1000 of FIG. 10, due to its large payload size, channel state information (CSI) may be divided into two parts (part1 1002/part2 1004) to report. CSI part 1 is typically considered more significant and has a smaller and fixed payload size (and is transmitted with higher reliability). CSI part 2 has a variable payload size dependent on the content of CSI part 1. In particular, the rank indicator (RI), number of layers, and number of non-zero coefficients (NNZC) in CSI part 1 determines the payload size of CSI part 2.

As noted above, in a baseline scheme for SD basis selection, a single encoded combination value is reported by a UE for each TRP. In particular, the selection of L beams out of N₁N₂ beams is indicated by an indicator

$${i}_{1 , 2} ∈ \{ 0 , 1 , … , ( \begin{matrix}{N}_{1} {N}_{2} \\ L\end{matrix} ) - 1 \} .$$

The encoding procedure for i_{1,2} (e.g., a mapping of beam index to the i_{1,2}) may be described as follows. Firstly, the UE determines the SD basis index in a 2-dimension grid of N₁N₂ beams, e.g., the i-th SD basis denoted by an index pair

$$( {n}_{1}^{( i )} , {n}_{2}^{( i )} ) where {n}_{1}^{( i )} ∈ \{ 0 , 1 , … , {N}_{1} - 1 \} and {n}_{2}^{( i )} ∈ \{ 0 , 1 , … , {N}_{2} - 1 \}$$

$$and i = 0 , 1 , … , L - 1 .$$

Then i_{1,2} is found using

$${i}_{1 , 2} = {\sum }_{i = 0}^{L - 1} C ( {N}_{1} {N}_{2} - 1 - {n}^{( i )} , L - i ) where {n}^{( i )} = {N}_{1} {n}_{2}^{( i )} + {n}_{1}^{( i )} and$$

$$C ( x , y ) = ( \begin{matrix}x \\ y\end{matrix} ) for x \geq y ;$$

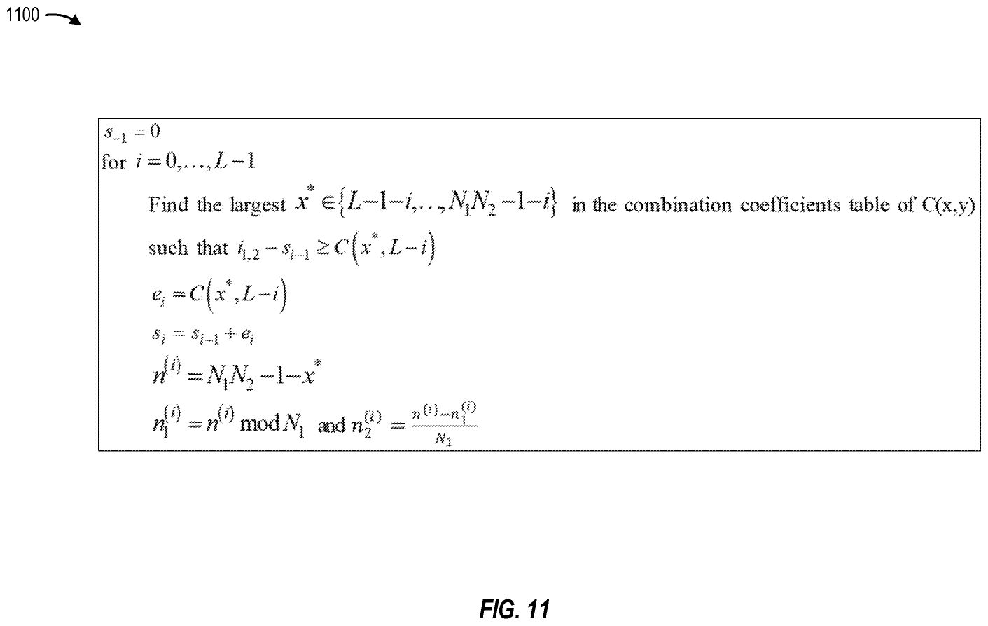

0 for x<y based on a pre-defined looking-up table. A corresponding decoding procedure for i_{i,2} (e.g., finding the SD basis indices from the i_{1,2}) may be understood with reference to the algorithm 1100 illustrated in FIG. 11.

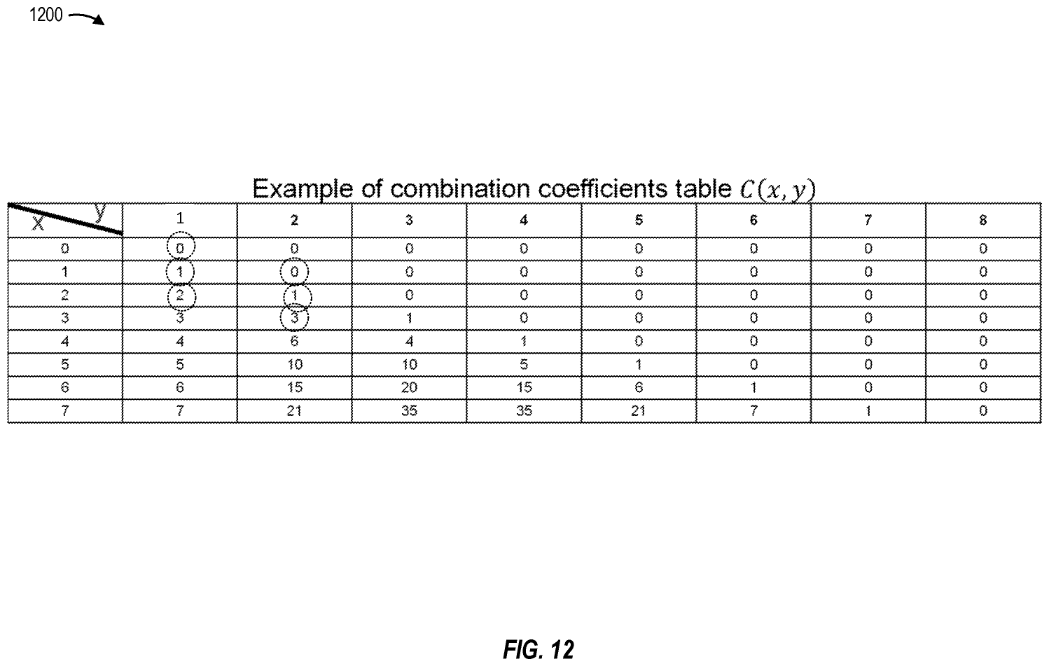

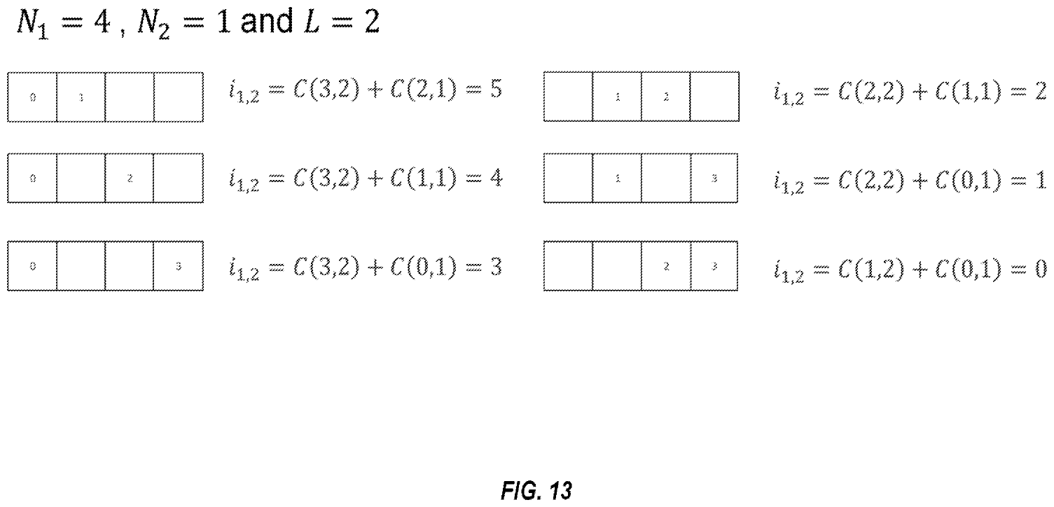

FIG. 12 illustrates an example table 1200 of combination coefficients C(x, y) that may be used to generate values of an indicator i_{1,2}, assuming an example of N₁=4, N₂=1 and L=2. The table may be used to generate the values shown in FIG. 13, based on the coefficients circled in FIG. 12. For example, a single encoded value of 5 may be reported, mapping to coefficients C(3,2)+C(2,1)=5 because C(3,2)=3 and C(2,1)=2.

### Aspects Related to Two-Stage Spatial Domain (SD) Basis Selection for Coherent Joint Transmission (CJT)

As noted above, the baseline scheme described above may have potential issues, such as a relatively large overhead when the value of Lₜₒₜ is large. For example, per-TRP SD basis selection may be reported using

$$⌈ {log}_{2} ( \begin{matrix}{N}_{1} {N}_{2} \\ {L}_{n}\end{matrix} ) ⌉$$

bits to indicate selection of Lₙ SD basis out of N₁N₂ bases for TRP n and a total

$${\sum }_{n = 1}^{N} ⌈ {log}_{2} ( \begin{matrix}{N}_{1} {N}_{2} \\ {L}_{n}\end{matrix} ) ⌉$$

bits for N TRPs with

$${L}_{tot} = {\sum }_{n = 1}^{N} {L}_{n}$$

where Lₜₒₜ is a gNB-configured value. In a worst case scenario (N=4, N₁N₂=16), a total 28 and 40 bits are required for Lₜₒₜ=8 and 12, respectively, assuming Lₙ=Lₜₒₜ/N. The baseline scheme is also relatively complex, since the SD basis selection is separately encoded or decoded for each TRP (e.g., N times complexity increase for encoding/decoding compared to the single TRP (sTRP) scenario).

Aspects of the present disclosure provide a mechanism for reporting per-TRP SD basis selection in multiple stages. For example, rather than report a single encoded combination value for each TRP, multiple indicators may be reported, resulting in reduced complexity and, in some cases, reduced overhead.

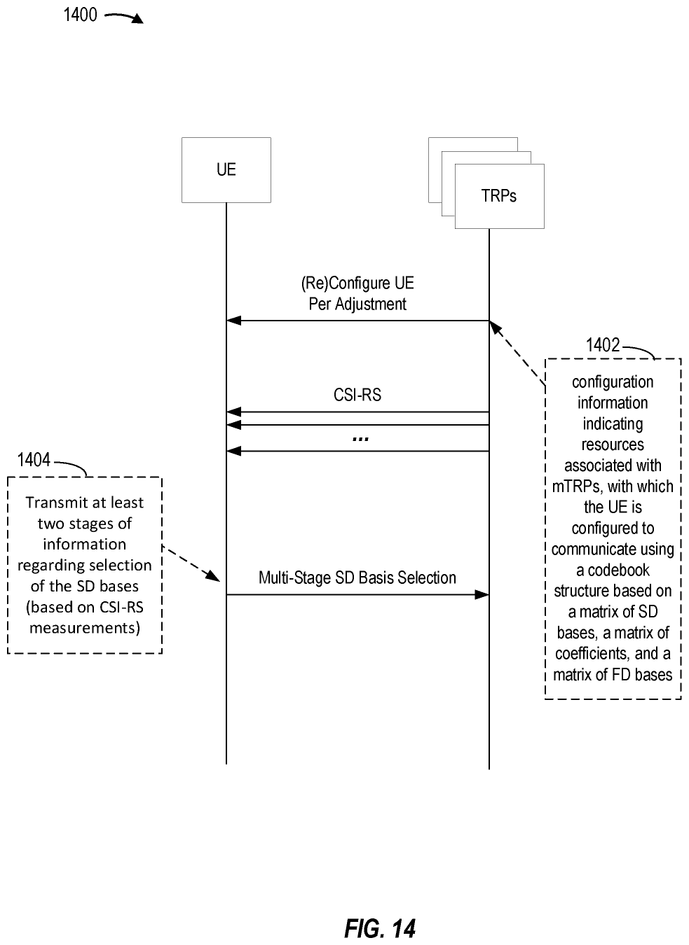

FIG. 14 depicts an example call flow diagram 1400 for multi-stage SD basis selection reporting, in accordance with aspects of the present disclosure. In some aspects, the TRPs depicted in FIG. 8 may be an example of a BS 102 depicted and described with respect to FIGS. 1 and 3. Similarly, the UE depicted in FIG. 8 may be an example of UE 104 depicted and described with respect to FIGS. 1 and 3.

As illustrated, at 1402, the UE may receive configuration information indicating resources associated with multiple transmission reception points (TRPs) with which the UE is configured to communicate using a codebook structure based on a matrix of spatial domain (SD) bases, a matrix of coefficients, and a matrix of frequency domain (FD) bases.

The UE may then measure channel state information (CSI) reference signals (CSI-RSs) from the multiple TRPs according to the configuration information. As illustrated at 1404, the UE may transmit at least two stages of information regarding selection of the SD bases.

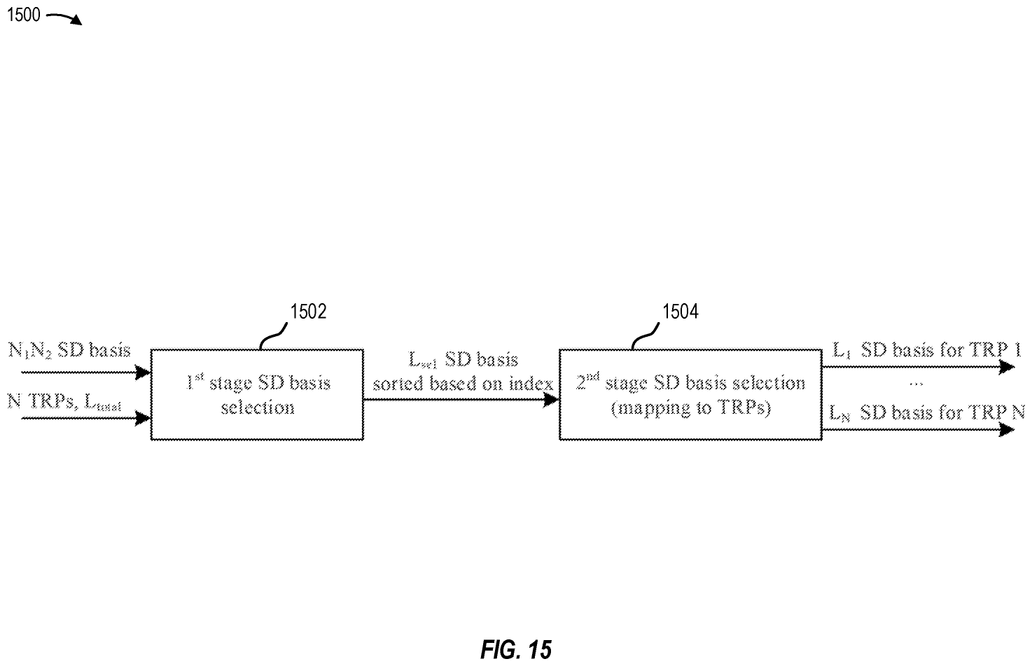

For example, as illustrated in diagram 1500 of FIG. 15, aspects of the present disclosure provide techniques for a two-stage SD basis selection.

In the first stage, as shown at 1502, a selection of Lₛₑₗ (Lₛₑₗ≤Lₜₒₜ) may be made. The selection may be of Lₛₑₗ non-overlapping SD basis out of N₁N₂ bases and the Lₛₑₗ SD basis, which may define a union set of all the SD basis selected across N TRPs.

In the second stage, as shown at 1504, for each TRP, an indication may be generated of a selection of Lₙ SD basis out of Lₛₑₗ bases where Lₙ is the number of SD basis selection for TRP n.

According to certain aspects, for the first stage SD basis selection, a bitmap of length N₁N₂ may be used to indicate a selection of Lₛₑₗ (Lₛₑₗ≤Lₜₒₜ) non-overlapping SD basis out of N₁N₂ bases. The value of Lₛₑₗ may be implicitly determined by the number of non-zero bits in the bitmap. The Lₛₑₗ non-overlapping SD bases may then sorted based on the corresponding SD basis index, which is defined as

$${n}^{( i )} = {N}_{1} {n}_{2}^{( i )} + {n}_{1}^{( i )} where {n}_{1}^{( i )} ∈ \{ 0 , 1 , … , {N}_{1} - 1 \} , {n}_{2}^{( i )} ∈ \{ 0 , 1 , … , {N}_{2} - 1 \}$$

$$and i = 1 , … , {L}_{sel} .$$

According to certain aspects, the second stage SD basis selection may be the mapping Lₛₑₗ SD basis to N TRPs.

According to a first option (Option 1), a bitmap of length N·Lₛₑₗ, may be used, assuming the value of Lₛₑₗ is separately reported. Each set of Lₛₑₗ bits may indicate the mapping of Lₛₑₗ SD bases to a different TRP. For example, the first Lₛₑₗ bits may indicate the mapping of Lₛₑₗ SD basis to the first TRP, the second Lₛₑₗ bits may indicate the mapping of Lₛₑₗ SD basis to the second TRP, and so on. A bit value of ‘1’ may indicate that the SD basis is selected for the corresponding TRP.

Alternatively, Each set of N bits may indicate the mapping of the first SD basis (of Lₛₑₗ SD bases) to the N TRPs. For example, the first N bits may indicate the mapping of the first SD basis of Lₛₑₗ SD basis to the N TRPs, the second N bits indicate the mapping of the second SD basis of Lₛₑₗ SD basis to the N TRPs, and so on. Again, the bit value of ‘1’ may indicate the SD basis is selected for the corresponding TRP.

According to this first option, the values of Lₙ can be implicitly determined by the number of nonzero bits in each subset of the bitmap and the total number of nonzero bits in the entire bitmap is equal to Lₜₒₜ.

According to a second option (Option 2), assuming the value of Lₙ is separately reported, following legacy, the selection of Lₙ SD basis out of Lₛₑₗ bases for TRP n may be indicated by

$$i ∈ \{ 0 , 1 , … , ( \begin{matrix}{L}_{sel} \\ {L}_{n}\end{matrix} ) - 1 \} .$$

In general, this may amount to reuse of the existing approach for sTRP, by replacing N₁N₂ with Lₛₑₗ. Since Lₛₑₗ is much lower than N₁N₂, both encoding and decoding complexity may be significantly reduced.

According to Option 1, the value of Lₛₑₗ may be reported in CSI part 1, following the legacy procedure, and the selection of Lₛₑₗ non-overlapping SD basis out of N₁N₂ bases may be indicated by an indicator by

$$i ∈ \{ 0 , 1 , … , ( \begin{matrix}{N}_{1} {N}_{2} \\ {L}_{sel}\end{matrix} ) - 1 \} .$$

For example,

$$⌈ {log}_{2} ( \begin{matrix}{N}_{1} {N}_{2} \\ {L}_{sel}\end{matrix} ) ⌉$$

bits may be used to indicate a selection of Lₛₑₗ SD basis out of N₁N₂ bases. If the value of Lₛₑₗ is not reported in CSI part 1, the bitmap of length N·Lₜₒₜ may be used for the 2nd stage selection and N(Lₜₒₜ−Lₛₑₗ) zero padding bits need to add for bitwidth alignment.

According to Option 2, Lₙ may be separately reported in CSI part 1. If not reported in CSI part 1, zero padding may be needed to a maximum value which can be pre-calculated for all the possible value combinations of Lₙ and Lₛₑₗ for a given N.

For Option 2, TRP grouping can also be used to further reduce the overhead. For example, N TRPs may be grouped into K groups where K is dependent on the value of Lₛₑₗ, and a single joint indicator for all the TRPs in the same group to indicate the SD basis selection for each TRP. For example, K=1 for Lₛₑₗ≤4, K=2 for 4<Lₛₑₗ≤8 and K=N for 8<Lₛₑₗ≤12 so that the maximum total number of SD basis across TRPs in each group is no larger than 16. For group k,

$$⌈ {log}_{2} ( \begin{matrix}{N}_{k} {L}_{sel} \\ {\sum }_{n = 1}^{{N}_{k}} {L}_{n}^{( k )}\end{matrix} ) ⌉$$

bits may be used to indicate a selection of

$${\sum }_{n = 1}^{{N}_{k}} {L}_{n}^{( k )} SD$$

basis out of all NₖLₛₑₗ bases where Nₖ is the number of TRPs in the group k.

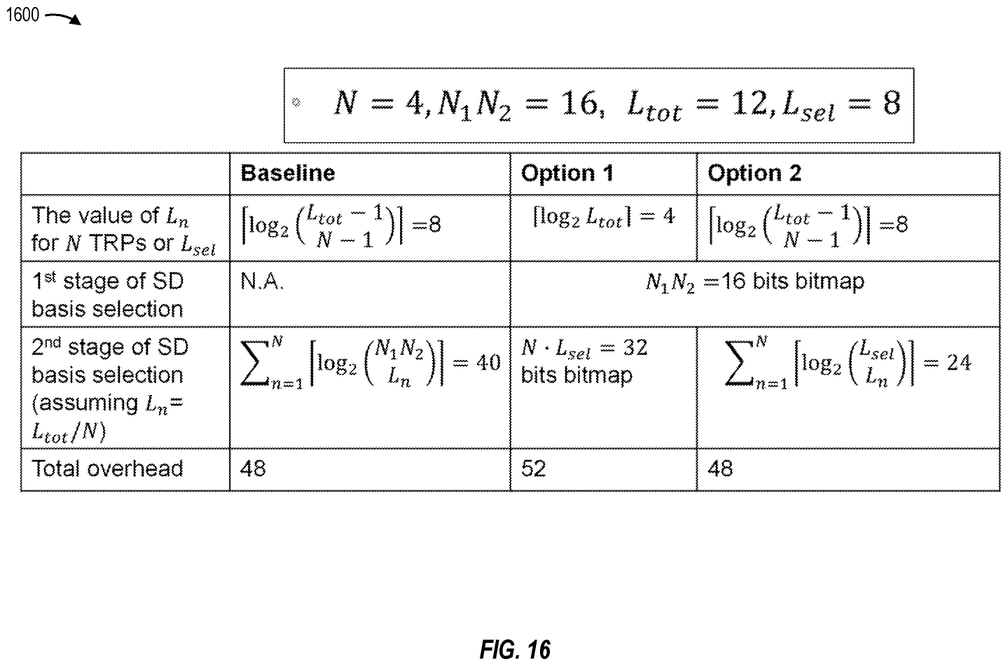

Table 1600 of FIG. 16 provides example of overhead comparisons for SD basis reporting using the baseline approach, Option 1, and Option 2 described above. As noted, the example assumes N=4, N₁N₂=16, Lₜₒₜ=12, and Lₛₑₗ=8. In this example, Option 1 has the largest overhead (52 bits), but with the simplest encoding/decoding due to the use of bitmap. Option 2 has comparable overhead (48 bits) to the baseline, but with reduced encoding/decoding complexity. Further, for Option 1, if the first stage selection indicator uses a combination number index, the number of feedback bits may be further reduced.

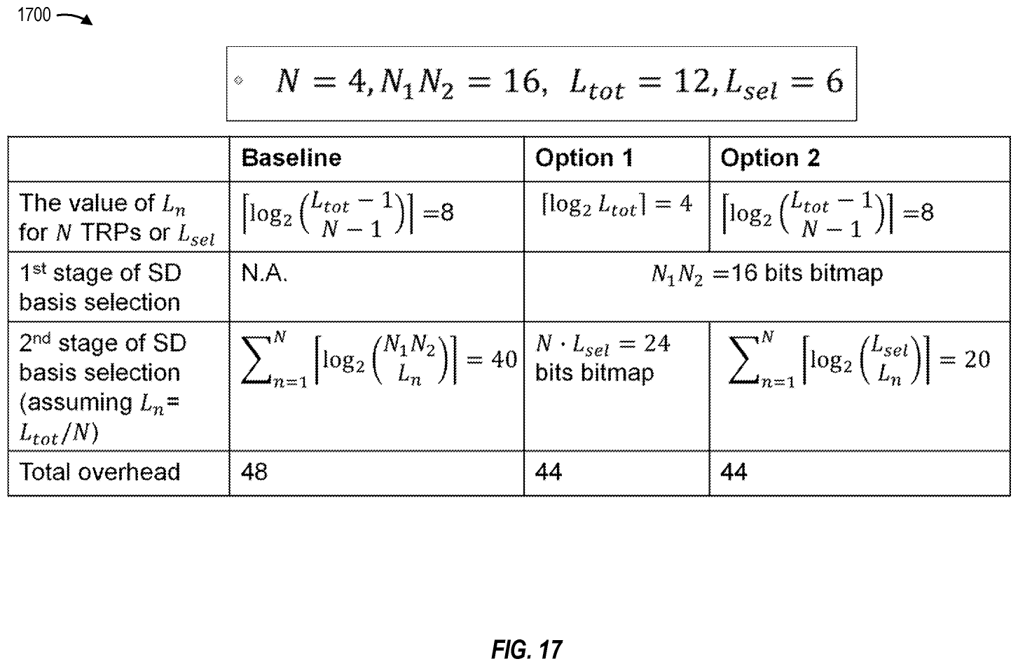

Table 1700 of FIG. 17 provides another example of overhead comparisons for SD basis reporting using the baseline approach, Option 1, and Option 2 described above. In this example, however, the assumptions are N=4, N₁N₂=16, Lₜₒₜ=12, Lₛₑₗ=6. As illustrated, both Option 1 and 2 have smaller overhead (44 bits) than the baseline (48 bits) when Lₛₑₗ=6.

As described herein, reporting per-TRP SD basis selection in multiple stages may result in reduced complexity and, in some cases, reduced overhead.

### Example Operations of a User Equipment

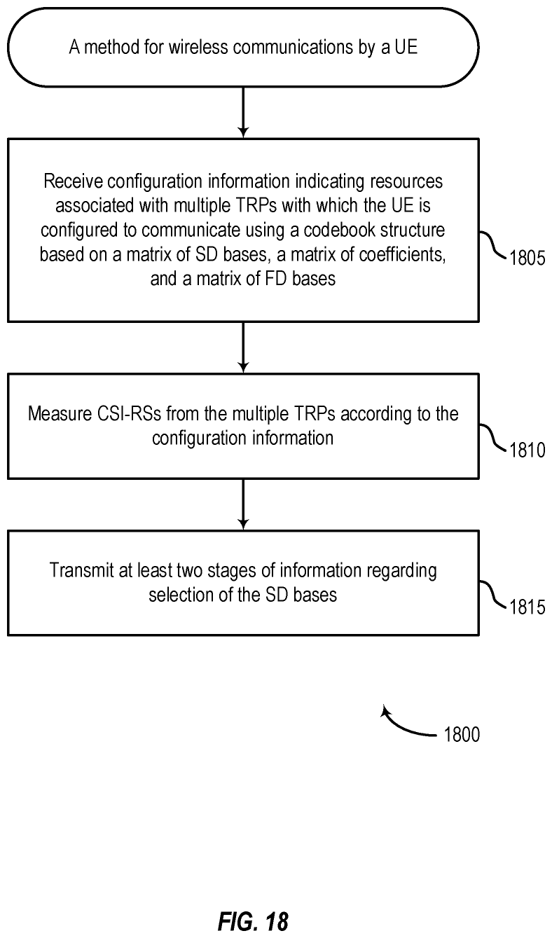

FIG. 18 shows an example of a method 1800 of wireless communication by a UE, such as a UE 104 of FIGS. 1 and 3.

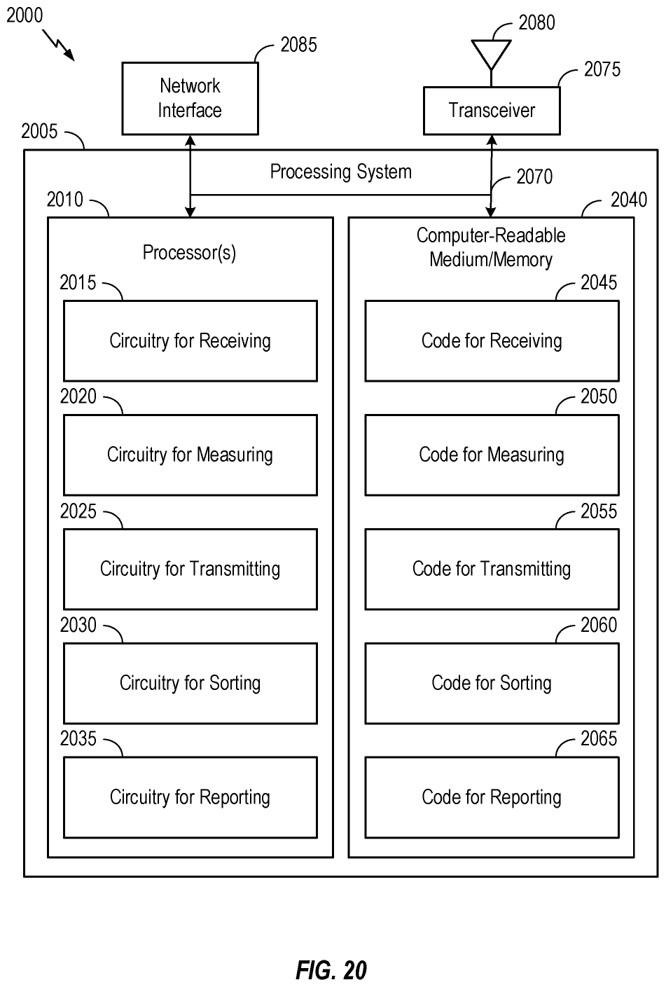

Method 1800 begins at step 1805 with receiving configuration information indicating resources associated with multiple TRPs with which the UE is configured to communicate using a codebook structure based on a matrix of SD bases, a matrix of coefficients, and a matrix of FD bases. In some cases, the operations of this step refer to, or may be performed by, circuitry for receiving and/or code for receiving as described with reference to FIG. 20.

Method 1800 then proceeds to step 1810 with measuring CSI-RSs from the multiple TRPs according to the configuration information. In some cases, the operations of this step refer to, or may be performed by, circuitry for measuring and/or code for measuring as described with reference to FIG. 20.

Method 1800 then proceeds to step 1815 with transmitting at least two stages of information regarding selection of the SD bases. In some cases, the operations of this step refer to, or may be performed by, circuitry for transmitting and/or code for transmitting as described with reference to FIG. 20.

In some aspects, the at least two stages of information comprise a first stage of information that indicates a first set of non-overlapping SD bases selected across all the multiple TRPs; and a second stage of information that indicates, for each of the multiple TRPs, of one or more SD bases selected from the first set for that TRP.

In some aspects, the first set of non-overlapping SD bases is selected from a larger group of SD bases.

In some aspects, the first set of non-overlapping SD bases is indicated, via the first stage of information, using a first bitmap with a length determined by a number of SD bases in the larger group of SD bases; and a number of non-zero bits in the first bitmap indicates the number of SD bases in the first set.

In some aspects, the method 1800 further includes sorting the SD bases of the first set based on corresponding SD basis indices. In some cases, the operations of this step refer to, or may be performed by, circuitry for sorting and/or code for sorting as described with reference to FIG. 20.

In some aspects, the second stage of information indicates a mapping of the SD bases in the first set to the multiple TRPs.

In some aspects, the mapping is indicated as a second bitmap with a length determined by the number of SD bases in the first set, Lₛₑₗ, and a number N of the multiple TRPs.

In some aspects, each Lₛₑₗ bits in the second bitmap indicate a mapping of the SD bases to a different TRP.

In some aspects, each N bits in the second bitmap indicate a mapping of a different one of the SD bases to the N TRPs.

In some aspects, the method 1800 further includes separately reporting a value of Lₛₑₗ. In some cases, the operations of this step refer to, or may be performed by, circuitry for reporting and/or code for reporting as described with reference to FIG. 20.

In some aspects, the second stage of information indicates a separate mapping for each of the multiple TRPs; and each separate mapping is indicated as a combination number which has a bit length determined by Lₛₑₗ and a number of SD bases selected for a corresponding TRP.

In some aspects, the method 1800 further includes reporting a number of SD bases selected for each of the multiple TRPs. In some cases, the operations of this step refer to, or may be performed by, circuitry for reporting and/or code for reporting as described with reference to FIG. 20.

In some aspects, the number of SD bases selected for each of the multiple TRPs is not reported; and the method further comprises adding zero padding bits to the combination number for the separate mapping of at least one of the TRPs for bit width alignment.

In some aspects, N multiple TRPs are grouped into K groups; and the second stage of information indicates a single indication of SD bases selection for all TRPs in each of the K groups.

In some aspects, a value of K depends on a number of SD bases in the first set, Lₛₑₗ.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

### Example Operations of a Network Entity

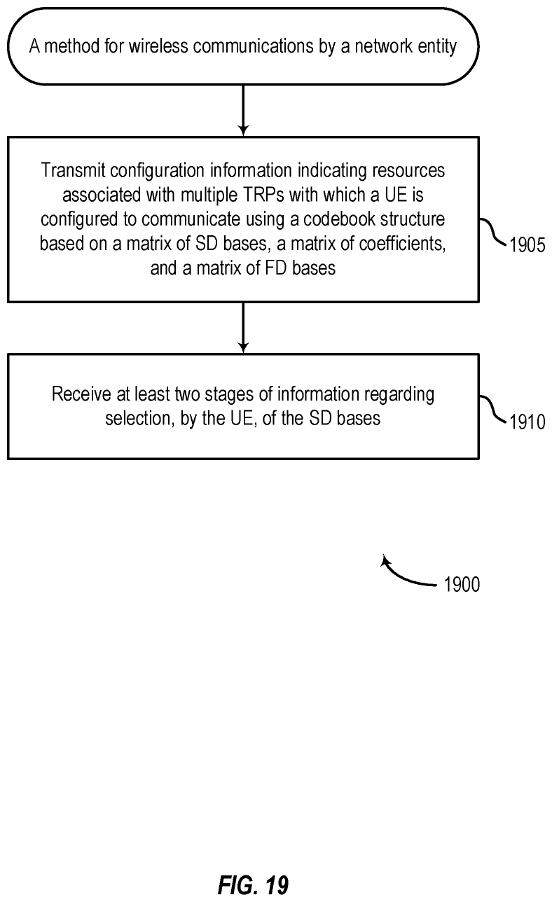

FIG. 19 shows an example of a method 1900 of wireless communication by a network entity, such as a BS 102 of FIGS. 1 and 3, or a disaggregated base station as discussed with respect to FIG. 2.

Method 1900 begins at step 1905 with transmitting configuration information indicating resources associated with multiple TRPs with which a UE is configured to communicate using a codebook structure based on a matrix of SD bases, a matrix of coefficients, and a matrix of FD bases. In some cases, the operations of this step refer to, or may be performed by, circuitry for transmitting and/or code for transmitting as described with reference to FIG. 20.

Method 1900 then proceeds to step 1910 with receiving at least two stages of information regarding selection, by the UE, of the SD bases. In some cases, the operations of this step refer to, or may be performed by, circuitry for receiving and/or code for receiving as described with reference to FIG. 20.

In some aspects, the at least two stages of information comprise a first stage of information that indicates a first set of non-overlapping SD bases selected across all the multiple TRPs; and a second stage of information that indicates, for each of the multiple TRPs, of one or more SD bases selected from the first set for that TRP.

In some aspects, the first set of non-overlapping SD bases is selected from a larger group of SD bases.

In some aspects, the first set of non-overlapping SD bases is indicated, via the first stage of information, using a first bitmap with a length determined by a number of SD bases in the larger group of SD bases; and a number of non-zero bits in the first bitmap indicates the number of SD bases in the first set.

In some aspects, the SD bases of the first set are sorted based on corresponding SD basis indices; and the second stage of information indicates a mapping of the SD bases in the first set to the multiple TRPs.

In some aspects, the mapping is indicated as a second bitmap with a length determined by the number of SD bases in the first set, Lₛₑₗ, and a number N of the multiple TRPs.

In some aspects, each Lₛₑₗ bits in the second bitmap indicate a mapping of the SD bases to a different TRP.

In some aspects, each N bits in the second bitmap indicate a mapping of a different one of the SD bases to the N TRPs.

In some aspects, the method 1900 further includes separately reporting a value of Lₛₑₗ. In some cases, the operations of this step refer to, or may be performed by, circuitry for reporting and/or code for reporting as described with reference to FIG. 20.

In some aspects, the second stage of information indicates a separate mapping for each of the multiple TRPs; and each separate mapping is indicated as a combination number which has a bit length determined by Lₛₑₗ and a number of SD bases selected for a corresponding TRP.

In some aspects, the method 1900 further includes reporting a number of SD bases selected for each of the multiple TRPs. In some cases, the operations of this step refer to, or may be performed by, circuitry for reporting and/or code for reporting as described with reference to FIG. 20.

In some aspects, the number of SD bases selected for each of the multiple TRPs is not reported; and the combination number for the separate mapping of at least one of the TRPs includes zero padding bits to for bit width alignment.

In some aspects, N multiple TRPs are grouped into K groups; and the second stage of information indicates a single indication of SD bases selection for all TRPs in each of the K groups.

In some aspects, a value of K depends on a number of SD bases in the first set, Lₛₑₗ.

In one aspect, method 1900, or any aspect related to it, may be performed by an apparatus, such as communications device 2000 of FIG. 20, which includes various components operable, configured, or adapted to perform the method 1900. Communications device 2000 is described below in further detail.

Note that FIG. 19 is just one example of a method, and other methods including fewer, additional, or alternative steps are possible consistent with this disclosure.

### Example Communications Device

FIG. 20 depicts aspects of an example communications device 2000. In some aspects, communications device 2000 is a user equipment, such as UE 104 described above with respect to FIGS. 1 and 3. In some aspects, communications device 2000 is a network entity, such as BS 102 of FIGS. 1 and 3, or a disaggregated base station as discussed with respect to FIG. 2.

The communications device 2000 includes a processing system 2005 coupled to the transceiver 2075 (e.g., a transmitter and/or a receiver). In some aspects (e.g., when communications device 2000 is a network entity), processing system 2005 may be coupled to a network interface 2085 that is configured to obtain and send signals for the communications device 2000 via communication link(s), such as a backhaul link, midhaul link, and/or fronthaul link as described herein, such as with respect to FIG. 2. The transceiver 2075 is configured to transmit and receive signals for the communications device 2000 via the antenna 2080, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2040 via a bus 2070. In certain aspects, the computer-readable medium/memory 2040 is configured to store instructions (e.g., computer-executable code) that when executed by the one or more processors 2010, cause the one or more processors 2010 to perform the method 1800 described with respect to FIG. 18, or any aspect related to it; and the method 1900 described with respect to FIG. 19, or any aspect related to it. Note that reference to a processor performing a function of communications device 2000 may include one or more processors 2010 performing that function of communications device 2000.

In the depicted example, computer-readable medium/memory 2040 stores code (e.g., executable instructions), such as code for receiving 2045, code for measuring 2050, code for transmitting 2055, code for sorting 2060, and code for reporting 2065. Processing of the code for receiving 2045, code for measuring 2050, code for transmitting 2055, code for sorting 2060, and code for reporting 2065 may cause the communications device 2000 to perform the method 1800 described with respect to FIG. 18, or any aspect related to it; and the method 1900 described with respect to FIG. 19, or any aspect related to it.

The one or more processors 2010 include circuitry configured to implement (e.g., execute) the code stored in the computer-readable medium/memory 2040, including circuitry for receiving 2015, circuitry for measuring 2020, circuitry for transmitting 2025, circuitry for sorting 2030, and circuitry for reporting 2035. Processing with circuitry for receiving 2015, circuitry for measuring 2020, circuitry for transmitting 2025, circuitry for sorting 2030, and circuitry for reporting 2035 may cause the communications device 2000 to perform the method 1800 described with respect to FIG. 18, or any aspect related to it; and the method 1900 described with respect to FIG. 19, or any aspect related to it.

Various components of the communications device 2000 may provide means for performing the method 1800 described with respect to FIG. 18, or any aspect related to it; and the method 1900 described with respect to FIG. 19, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2075 and the antenna 2080 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2075 and the antenna 2080 of the communications device 2000 in FIG. 20.

### EXAMPLE CLAUSES

Implementation examples are described in the following numbered clauses:
Clause 1: A method for wireless communications by a UE, comprising: receiving configuration information indicating resources associated with multiple TRPs with which the UE is configured to communicate using a codebook structure based on a matrix of SD bases, a matrix of coefficients, and a matrix of FD bases; measuring CSI-RSs from the multiple TRPs according to the configuration information; and transmitting at least two stages of information regarding selection of the SD bases.
Clause 2: The method of Clause 1, wherein the at least two stages of information comprise a first stage of information that indicates a first set of non-overlapping SD bases selected across all the multiple TRPs; and a second stage of information that indicates, for each of the multiple TRPs, of one or more SD bases selected from the first set for that TRP.
Clause 3: The method of Clause 2, wherein the first set of non-overlapping SD bases is selected from a larger group of SD bases.
Clause 4: The method of Clause 3, wherein the first set of non-overlapping SD bases is indicated, via the first stage of information, using a first bitmap with a length determined by a number of SD bases in the larger group of SD bases; and a number of non-zero bits in the first bitmap indicates the number of SD bases in the first set.
Clause 5: The method of Clause 4, further comprising: sorting the SD bases of the first set based on corresponding SD basis indices.
Clause 6: The method of Clause 5, wherein, the second stage of information indicates a mapping of the SD bases in the first set to the multiple TRPs.
Clause 7: The method of Clause 6, wherein the mapping is indicated as a second bitmap with a length determined by the number of SD bases in the first set, Lₛₑₗ, and a number N of the multiple TRPs.
Clause 8: The method of Clause 7, wherein each Lₛₑₗ bits in the second bitmap indicate a mapping of the SD bases to a different TRP.
Clause 9: The method of Clause 7, wherein each N bits in the second bitmap indicate a mapping of a different one of the SD bases to the N TRPs.
Clause 10: The method of Clause 7, further comprising: separately reporting a value of Lₛₑₗ.
Clause 11: The method of Clause 6, wherein the second stage of information indicates a separate mapping for each of the multiple TRPs; and each separate mapping is indicated as a combination number which has a bit length determined by Lₛₑₗ and a number of SD bases selected for a corresponding TRP.
Clause 12: The method of Clause 11, further comprising: reporting a number of SD bases selected for each of the multiple TRPs.
Clause 13: The method of Clause 11, wherein the number of SD bases selected for each of the multiple TRPs is not reported; and the method further comprises adding zero padding bits to the combination number for the separate mapping of at least one of the TRPs for bit width alignment.
Clause 14: The method of Clause 11, wherein N multiple TRPs are grouped into K groups; and the second stage of information indicates a single indication of SD bases selection for all TRPs in each of the K groups.
Clause 15: The method of Clause 14, wherein a value of K depends on a number of SD bases in the first set, Lₛₑₗ.
Clause 16: A method for wireless communications by a network entity, comprising: transmitting configuration information indicating resources associated with multiple TRPs with which a UE is configured to communicate using a codebook structure based on a matrix of SD bases, a matrix of coefficients, and a matrix of FD bases; and receiving at least two stages of information regarding selection, by the UE, of the SD bases.
Clause 17: The method of Clause 16, wherein the at least two stages of information comprise a first stage of information that indicates a first set of non-overlapping SD bases selected across all the multiple TRPs; and a second stage of information that indicates, for each of the multiple TRPs, of one or more SD bases selected from the first set for that TRP.
Clause 18: The method of Clause 17, wherein the first set of non-overlapping SD bases is selected from a larger group of SD bases.
Clause 19: The method of Clause 18, wherein the first set of non-overlapping SD bases is indicated, via the first stage of information, using a first bitmap with a length determined by a number of SD bases in the larger group of SD bases; and a number of non-zero bits in the first bitmap indicates the number of SD bases in the first set.
Clause 20: The method of Clause 19, wherein the SD bases of the first set are sorted based on corresponding SD basis indices; and the second stage of information indicates a mapping of the SD bases in the first set to the multiple TRPs.
Clause 21: The method of Clause 20, wherein the mapping is indicated as a second bitmap with a length determined by the number of SD bases in the first set, Lₛₑₗ, and a number N of the multiple TRPs.
Clause 22: The method of Clause 21, wherein each Lₛₑₗ bits in the second bitmap indicate a mapping of the SD bases to a different TRP.
Clause 23: The method of Clause 21, wherein each Nbits in the second bitmap indicate a mapping of a different one of the SD bases to the N TRPs.
Clause 24: The method of Clause 21, further comprising: separately reporting a value of Lₛₑₗ.
Clause 25: The method of Clause 21, wherein the second stage of information indicates a separate mapping for each of the multiple TRPs; and each separate mapping is indicated as a combination number which has a bit length determined by Lₛₑₗ and a number of SD bases selected for a corresponding TRP.
Clause 26: The method of Clause 25, further comprising: reporting a number of SD bases selected for each of the multiple TRPs.
Clause 27: The method of Clause 25, wherein the number of SD bases selected for each of the multiple TRPs is not reported; and the combination number for the separate mapping of at least one of the TRPs includes zero padding bits to for bit width alignment.
Clause 28: The method of Clause 25, wherein N multiple TRPs are grouped into K groups; and the second stage of information indicates a single indication of SD bases selection for all TRPs in each of the K groups.
Clause 29: The method of Clause 28, wherein a value of K depends on a number of SD bases in the first set, Lₛₑₗ.
Clause 30: An apparatus, comprising: a memory comprising executable instructions; and a processor configured to execute the executable instructions and cause the apparatus to perform a method in accordance with any one of Clauses 1-29.
Clause 31: An apparatus, comprising means for performing a method in accordance with any one of Clauses 1-29.
Clause 32: A non-transitory computer-readable medium comprising executable instructions that, when executed by a processor of an apparatus, cause the apparatus to perform a method in accordance with any one of Clauses 1-29.
Clause 33: A computer program product embodied on a computer-readable storage medium comprising code for performing a method in accordance with any one of Clauses 1-29.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
receiving configuration information indicating resources associated with multiple transmission reception points (TRPs) with which the UE is configured to communicate using a codebook structure based on a matrix of spatial domain (SD) bases, a matrix of coefficients, and a matrix of frequency domain (FD) bases;
measuring channel state information (CSI) reference signals (CSI-RSs) from the multiple TRPs according to the configuration information; and
transmitting at least two stages of information regarding selection of the SD bases.

2. The method of claim 1, wherein the at least two stages of information comprise:
a first stage of information that indicates a first set of non-overlapping SD bases selected across all the multiple TRPs; and
a second stage of information that indicates, for each of the multiple TRPs, of one or more SD bases selected from the first set for that TRP.

3. The method of claim 2, wherein the first set of non-overlapping SD bases is selected from a larger group of SD bases.

4. The method of claim 3, wherein:
the first set of non-overlapping SD bases is indicated, via the first stage of information, using a first bitmap with a length determined by a number of SD bases in the larger group of SD bases; and
a number of non-zero bits in the first bitmap indicates the number of SD bases in the first set.

5. The method of claim 4, further comprising:
sorting the SD bases of the first set based on corresponding SD basis indices.

6. The method of claim 5, wherein, the second stage of information indicates a mapping of the SD bases in the first set to the multiple TRPs.

7. The method of claim 6, wherein the mapping is indicated as a second bitmap with a length determined by the number of SD bases in the first set, Lsel, and a number N of the multiple TRPs.

8. The method of claim 7, wherein each Lsel bits in the second bitmap indicate a mapping of the SD bases to a different TRP.

9. The method of claim 7, wherein each N bits in the second bitmap indicate a mapping of a different one of the SD bases to the N TRPs.

10. The method of claim 7, further comprising separately reporting a value of Lsel.

11. The method of claim 6, wherein:
the second stage of information indicates a separate mapping for each of the multiple TRPs; and
each separate mapping is indicated as a combination number which has a bit length determined by Lsel and a number of SD bases selected for a corresponding TRP.

12. The method of claim 11, further comprising reporting a number of SD bases selected for each of the multiple TRPs.

13. The method of claim 11, wherein:
the number of SD bases selected for each of the multiple TRPs is not reported; and
the method further comprises adding zero padding bits to the combination number for the separate mapping of at least one of the TRPs for bit width alignment.

14. The method of claim 11, wherein:
N multiple TRPs are grouped into K groups; and
the second stage of information indicates a single indication of SD bases selection for all TRPs in each of the K groups.

15. The method of claim 14, wherein a value of K depends on a number of SD bases in the first set, Lsel.

16. A method for wireless communications by a network entity, comprising:
transmitting configuration information indicating resources associated with multiple transmission reception points (TRPs) with which a user equipment (UE) is configured to communicate using a codebook structure based on a matrix of spatial domain (SD) bases, a matrix of coefficients, and a matrix of frequency domain (FD) bases; and
receiving at least two stages of information regarding selection, by the UE, of the SD bases.

17-29. (canceled)

30. An apparatus, comprising: a memory comprising executable instructions; and a processor configured to execute the executable instructions and cause the apparatus
receive configuration information indicating resources associated with multiple transmission reception points (TRPs) with which the UE is configured to communicate using a codebook structure based on a matrix of spatial domain (SD) bases, a matrix of coefficients, and a matrix of frequency domain (FD) bases;
measure channel state information (CSI) reference signals (CSI-RSs) from the multiple TRPs according to the configuration information; and
transmit at least two stages of information regarding selection of the SD bases.

31-33. (canceled)

34. The apparatus of claim 30, wherein the at least two stages of information comprise:
a first stage of information that indicates a first set of non-overlapping SD bases selected across all the multiple TRPs; and
a second stage of information that indicates, for each of the multiple TRPs, of one or more SD bases selected from the first set for that TRP.

35. The apparatus of claim 34, wherein the first set of non-overlapping SD bases is selected from a larger group of SD bases.

36. The apparatus of claim 35, wherein:
the first set of non-overlapping SD bases is indicated, via the first stage of information, using a first bitmap with a length determined by a number of SD bases in the larger group of SD bases; and
a number of non-zero bits in the first bitmap indicates the number of SD bases in the first set.
